(19) United States
(12) Patent Application Publication
(10) Pub. No.: US 2017/0275447 A1
(43) Pub. Date: Sep. 28, 2017

(54) AQUEOUS CROSS-LINKABLE POLYMER DISPERSIONS

(71) Applicant: Celanese International Corporation, Irving, TX (US)

(72) Inventors: Matthias JUNK, Alsbach-Hahnlein (DE); Stephan KRIEGER, Hofheim (DE); Ulrich DESOR, Idstein (DE)

(21) Appl. No.: 15/464,013

(22) Filed: Mar. 20, 2017

Related U.S. Application Data
(60) Provisional application No. 62/312,654, filed on Mar. 24, 2016.

(51) Int. Cl. C08L 33/12; C09D 11/033; C09J 133/12; C09D 11/107; C08J 3/12; C09D 133/12

(52) U.S. Cl. CPC C08L 33/12; C08J 3/12; C09D 133/12; C09J 133/12; C09D 11/107; C09D 11/033; C08L 2201/54; C08L 2312/00; C08J 2333/12

(57) ABSTRACT

An aqueous cross-linkable copolymer dispersion is formed by emulsion polymerization of a monomer mixture comprising at least one ethylenically unsaturated main monomer and at least one 1,3-dicarbonyl functionalized monomer and lysine or a salt thereof.

### CROSS REFERENCE TO RELATED APPLICATIONS

This application claims the benefit of the filing date of U.S. Provisional Application No. 62/312,654 filed Mar. 24, 2016, the entire contents of which are incorporated herein by reference

### FIELD

The present development relates to aqueous cross-linkable polymer dispersions.

### BACKGROUND

Polymer dispersions are widely used as binders in water-based coatings, adhesives, and printing inks. The polymer dispersion is applied to a substrate and dried to form a film via coalescence to obtain desired mechanical and physical properties. Coalescence is a process whereby polymer particles in aqueous dispersion come into contact with one another during drying, and polymer chains diffuse across boundaries of the dispersion particles to yield continuous films with good bonding of the particles.

One method of improving the properties of films formed from polymer dispersions is to include polymers that are capable of cross-linking. The polymers may be self cross-linking or require a cross-linking agent to react with the polymers. The cross-linking agents can be used to cross-link the binders and/or other polymeric additives such as polymeric surfactants and dispersants (U.S. Pat. No. 5,348,997) or rheology modifiers (U.S. Published Patent Application No. 2009/0162669). Cross-linking of polymers in coatings, inks, and other water-borne film-forming compositions can improve physical and mechanical strength, adhesion, and durability. In coating applications, cross-linking may also improve scrubability, block resistance, chemical resistance, and weatherability (See U.S. Pat. No. 7,547,740 and U.S. Patent Application Publication No. 2007/0265391). Cross-linking of polymer constituents may also enhance adhesion and bonding strength for adhesives. Additionally, cross-linking is widely utilized in the formulation of printing inks, in order to improve the mechanical and chemical resistance of prints.

A widely applied cross-linking system for water-borne polymer dispersions, particularly those including (meth)acrylic monomers, includes the addition of a carbonyl-functional co-monomer, such as diacetone acrylamide (“DAAM”), in the monomer mixture used to produce the (meth)acrylic polymer binder together with an external cross-linking agent, such as adipic acid dihydrazide (“ADH”). Such a cross-linking system comprising a carbonyl-functional co-monomer and a multifunctional dihydrazide component was first introduced by Kuehlkamp et al. (U.S. Pat. No. 3,345,336). For its versatile application in water-borne adhesives, coating compositions and printing inks, reference is directed to U.S. Pat. Nos. 4,529,772, 4,609,420, 4,959,428, and 6,005,042 as well as US Published Patent Application No. 2013/042472. However, the recent regulatory reclassification of ADH as an aquatoxin makes the use of this compound undesirable. Further, the use of hydrazine derivatives is under discussion as hydrazine is toxic and carcinogenic, and the cleavage of trace amounts of hydrazine from its derivatives cannot be completely excluded. There is therefore significant interest in developing alternative cross-linking systems to DAAM/ADH particularly for acrylic-based water-borne polymer dispersions.

### SUMMARY

According to the invention, it has now been found that an attractive replacement for the DAAM/ADH cross-linking system comprises a combination of a 1,3-dicarbonyl-functionalized comonomer, such as 2-acetoacetoxyethyl methacrylate (AAEM), and lysine or a lysine salt. In contrast to other diamines, lysine is not subject to regulatory restrictions. It is a colorless and odorless solid and is miscible with water up to high concentrations and over a wide pH range. Dispersions comprising 1,3-dicarbonyl-functionalized monomers and lysine retain the desirable chemical and mechanical resistances of those dispersions comprising DAAM/ADH without having the disadvantage of using aquatoxic components.

Thus, in one aspect, the invention resides in an aqueous cross-linkable copolymer dispersion formed by emulsion polymerization of a monomer mixture comprising at least one ethylenically unsaturated main monomer and at least one 1,3-dicarbonyl functionalized monomer; and lysine or a salt thereof.

In one embodiment, the at least one ethylenically unsaturated main monomer is selected from the group consisting of vinyl esters of C₁-C₁₈ alkanoic acids, vinyl esters of aromatic acids, α-olefins, dienes, esters of ethylenically unsaturated carboxylic acids, vinylaromatics, and vinylhalogenides.

In one embodiment, the at least one 1,3-dicarbonyl functionalized monomer comprises an acetoacetyl group, for example an acetoacetoxyalkyl ester of acrylic or methacrylic acid, preferably 2-acetoacetoxyethyl methacrylate.

### DETAILED DESCRIPTION

An aqueous cross-linkable copolymer dispersion is described which is formed by emulsion polymerization of a monomer mixture comprising at least one ethylenically unsaturated main monomer and at least one 1,3-dicarbonyl functionalized monomer together with a cross-linking agent comprising lysine or a salt thereof. The dispersion is useful as a binder in water-borne coating compositions, such as paints and lacquers, in adhesives, and in printing inks.

### Monomer Mixture

The aqueous monomer mixture used to produce the present polymer dispersion comprises one or more ethylenically unsaturated main monomers. Suitable main monomers are selected from esters of ethylenically unsaturated carboxylic acids, vinyl esters of C₁-C₁₈ alkanoic acids, vinyl-aromatic compounds having up to 20 carbon atoms, vinyl esters of aromatic acids, C₂-C₈ aliphatic hydrocarbons with 1 or 2 double bonds, ethylenically unsaturated nitriles, vinyl halides, vinyl ethers of C₁-C₁₀ alcohols, and mixtures of these monomers.

Suitable esters of ethylenically unsaturated carboxylic acids include C₁-C₁₈ alkyl esters of ethylenically unsaturated carboxylic acids, such as acrylic acid, methacrylic acid, maleic acid and fumaric acid. Examples include methyl acrylate, ethyl acrylate, n-propyl acrylate, isopropyl acrylate, n-butyl acrylate, t-butyl acrylate, 1-hexyl acrylate, 2-ethylhexyl acrylate, heptyl acrylate, octyl acrylate, 2-propylpentyl acrylate, 1-propylheptyl acrylate, lauryl acrylate, methyl methacrylate, methyl ethacrylate, n-propyl methacrylate, isopropyl methacrylate, n-butyl methacrylate, isobutyl methacrylate, tert-butyl methacrylate, isobornyl methacrylate and cyclohexyl methacrylate. Mixtures of alkyl (meth)acrylates can also be employed.

Examples of suitable vinyl esters of C₁-C₁₈ alkanoic acids include vinyl acetate, vinyl propionate, vinyl laurate, vinyl stearate, and Versatic acid vinyl esters, with vinyl acetate being particularly preferred.

Suitable vinyl-aromatic compounds include vinyltoluene, α- and p-methylstyrene, α-butylstyrene, 4-n-butylstyrene, 4-n-decyl-styrene and, preferably, styrene.

Examples of suitable C₂-C₈ aliphatic hydrocarbons with one olefinic double bond include, for example, ethene and propene, whereas representative examples of C₂-C₈ aliphatic hydrocarbons having two olefinic double bonds include butadiene, isoprene and chloroprene.

Examples of suitable ethylenically unsaturated nitriles include acrylonitrile and methacrylonitrile.

Suitable vinyl halides include chloro-, fluoro- or bromo-substituted ethylenically unsaturated compounds, such as vinyl chloride and vinylidene chloride.

Examples of vinyl ethers are vinyl methyl ether and vinyl iso-butyl ether, with preference being given to vinyl ethers of C₁-C₄ alcohols.

In some embodiments, the main monomer mixture comprises at least one C₁-C₁₂ alkyl ester of acrylic or methacrylic acid and preferably from 50 to 99 pphm of said at least one C₁-C₁₂ alkyl ester of acrylic or methacrylic acid, where pphm means parts by weight per hundred parts by weight of the total monomers used in the emulsion polymerization process.

In addition to the main monomers listed above, the monomer mixture employed to produce the polymer dispersion includes at least one 1,3-dicarbonyl functionalized monomer. In one embodiment, the at least one 1,3-dicarbonyl functionalized monomer comprises an acetoacetyl group and preferably comprises an acetoacetoxyalkyl ester of acrylic or methacrylic acid, where the alkyl group has from 2 to 4 carbon atoms. Examples of suitable polymerizable 1,3-dicarbonyl functionalized monomers include acetoacetoxyethyl acrylate, acetoacetoxyethyl methacrylate (AAEM), acetoacetoxypropyl methacrylate, acetoacetoxybutyl methacrylate, 2,3-di(acetoacetoxy)propyl methacrylate and allyl acetoacetate. Suitable polymerizable 1,3-diketoamides include those compounds described in U.S. Pat. No. 5,889,098, which patent is incorporated herein by reference. Examples of compounds of this type include amido acetoacetonates such as 3-isopropenyl-α,α-dimethylbenzyl amidoacetoacetate, 4-isopropenyl-α,α-dimethylbenzyl amidoacetoacetate, 4-ethylenyl-phenyl amidoacetoacetate and the like. A preferred 1,3-dicarbonyl functionalized monomer comprises 2-acetoacetoxyethyl methacrylate. In one embodiment, the monomer mixture comprises from 0.5 to 10 pphm, such as from 1 to 7.5 pphm, of at least one 1,3-dicarbonyl functionalized monomer.

In addition, to the main monomer(s) and 1,3-dicarbonyl functionalized monomer, the monomer mixture employed herein may include up to 10 pphm, such as from 0.5 to 5 pphm, of one or more acid monomers comprising at least one of an ethylenically unsaturated carboxylic acid or an anhydride or amide thereof, an ethylenically unsaturated sulfonic acid, or an ethylenically unsaturated phosphonic or phosphoric acid.

For example, the acid monomer may comprise an ethylenically unsaturated C₃-C₈ monocarboxylic acid and/or an ethylenically unsaturated C₄-C₈ dicarboxylic acid, together with the anhydrides or amides thereof. Examples of suitable ethylenically unsaturated C₃-C₈ monocarboxylic acids include acrylic acid, methacrylic acid and crotonic acid. Examples of suitable ethylenically unsaturated C₄-C₈ dicarboxylic acids include maleic acid, fumaric acid, itaconic acid and citraconic acid.

Examples of suitable ethylenically unsaturated sulfonic acids include those having 2-8 carbon atoms, such as vinylsulfonic acid, 2-acrylamido-2-methylpropanesulfonic acid, 2-acryloyloxyethanesulfonic acid and 2-methacryloyloxyethanesulfonic acid, 2-acryloyloxy- and 3-methacryloyloxypropanesulfonic acid. Examples of suitable ethylenically unsaturated phosphonic or phosphoric acids include vinylphosphonic acid, esters of phosphonic or phosphoric acid with hydroxyalkyl(meth)acrylates and ethylenically unsaturated polyethoxyalkyletherphosphates.

In addition to or instead of said acids, it is also possible to use the salts thereof, preferably the alkali metal or ammonium salts thereof, particularly preferably the sodium salts thereof, such as, for example, the sodium salts of vinylsulfonic acid and of 2-acrylamidopropanesulfonic acid.

The present crosslinking system of a 1,3-dicarbonyl functional comonomer and lysine can universally be applied in polymer dispersions, in certain embodiments also in combination with other functional monomers and/or crosslinkers. As such, the monomer composition employed to produce the polymer dispersion employed herein may include up to 10 pphm, such as from 0.5 to 5 pphm, of one or more functional co-monomers adapted to promote better film or coating performance by the final coating composition. Such desirable film/coating properties can include, for example, enhanced adhesion to surfaces or substrates, improved wet adhesion, better resistance to removal by scrubbing or other types of weathering or abrasion, and improved resistance to film or coating cracking. The optional co-monomers useful for incorporation into the emulsion copolymers of the compositions herein are those which contain one polymerizable double bond along with one or more additional functional moieties. Such optional or auxiliary co-monomers can include unsaturated silane co-monomers, glycidyl co-monomers, ureido co-monomers, other carbonyl-functional monomers than the 1,3-dicarbonyl functionalized monomers described above and combinations of these auxiliary optional co-monomers.

Unsaturated silanes useful as optional co-monomers can generally correspond to a substituted silane of the structural Formula I:

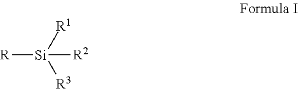

in which R denotes an organic radical olefinically unsaturated in the ω-position and R¹, R² and R³, which may be identical or different, denote the group —OZ, Z denoting hydrogen or primary or secondary alkyl or acyl radicals optionally substituted by alkoxy groups. Suitable unsaturated silane compounds of Formula I are preferably those in which the radical R in the formula represents an ω-unsaturated alkenyl of 2 to 10 carbon atoms, particularly of 2 to 4 carbon atoms, or an ω-unsaturated carboxylic acid ester formed from unsaturated carboxylic acids of up to 4 carbon atoms and alcohols of up to 6 carbon atoms carrying the Si group. Suitable radicals R¹, R², R³ are preferably the group —OZ, Z representing primary and/or secondary alkyl radicals of up to 10 carbon atoms, preferably up to 4 carbon atoms, or alkyl radicals substituted by alkoxy groups, preferably of up to 3 carbon atoms, or acyl radicals of up to 6 carbon atoms, preferably of up to 3 carbon atoms, or hydrogen. Most preferred unsaturated silane co-monomers are vinyl trialkoxy silanes.

Glycidyl compounds can also be used as optional functional co-monomers to impart epoxy-functionality to the emulsion copolymer. Examples of suitable glycidyl optional co-monomers include glycidyl acrylate, glycidyl methacrylate, allyl glycidyl ether, and vinyl glycidyl ether.

Another type of functional co-monomer comprises cyclic ureido co-monomers. Cyclic ureido co-monomers are known to impart improved wet adhesion properties to films and coatings formed from copolymers containing these co-monomers. Cyclic ureido compounds and their use as wet adhesion promoting co-monomers are disclosed in U.S. Pat. Nos. 4,104,220; 4,111,877; 4,219,454; 4,319,032; 4,599,417 and 5,208,285. The disclosures of all of these U.S. patents are incorporated herein by reference in their entirety.

Suitable carbonyl-containing co-monomers, other than the 1,3-dicarbonyl functionalized monomers described above, include diacetone acrylamide (DAAM).

Optionally, the monomer compositions used in the present process may also contain up to 3 pphm, such as from 0.1 to 2 pphm, of monomers with at least two non-conjugated ethylenically unsaturated groups. Such cross-linking co-monomers include triallyl cyanurate, triallyl isocyanurate, diallyl maleate, diallyl fumarate, divinyl benzene, diallyl phthalate, hexanediol diacrylate, ethyleneglycol dimethacrylate, and polyethylene glycol diacrylate.

### Production of the Polymer Dispersion

The desired polymer dispersion is produced by free radical emulsion polymerization of the monomers described above in an aqueous medium and in the presence of one or more free radical initiators. The polymerization can be conducted either in a single stage or in multiple stages. Where polymerization is conducted in multiple stages, the monomer mixture polymerized in at least one stage comprises at least one 1,3-dicarbonyl functionalized monomer.

Suitable free radical initiators include hydrogen peroxide, benzoyl peroxide, cyclohexanone peroxide, isopropyl cumyl hydroperoxide, persulfates of potassium, of sodium and of ammonium, peroxides of saturated monobasic aliphatic carboxylic acids having an even number of carbon atoms and a C₈-C₁₂ chain length, tert-butyl hydroperoxide, di-tert-butyl peroxide, diisopropyl percarbonate, azoisobutyronitrile, acetylcyclohexanesulfonyl peroxide, tert-butyl perbenzoate, tert-butyl peroctanoate, bis(3,5,5-trimethyl)hexanoyl peroxide, tert-butyl perpivalate, hydroperoxypinane, p-methane hydroperoxide. The abovementioned compounds can also be used within redox systems, using transition metal salts, such as iron(II) salts, or other reducing agents. Alkali metal salts of oxymethanesulfinic acid, hydroxylamine salts, sodium dialkyldithiocarbamate, sodium bisulfite, ammonium bisulfite, sodium dithionite, diisopropyl xanthogen disulfide, ascorbic acid, tartaric acid, and isoascorbic acid can also be used as reducing agents.

The conditions in the or each polymerization stage generally include a temperature between from 40 to 120° C., preferably from 50 to 110° C., and most preferably from 60 to 95° C.

The glass transition temperature (T_{g}) of the polymer dispersion may be adjusted depending on the desired application. Dispersions as binders in matte interior and exterior paints and plasters may possess a T_{g} in the range of −5 to 30° C., while dispersions for use in adhesives typically possess a T_{g}<0° C. To obtain block resistant water-borne lacquers, stains, and varnishes comprising little or no coalescing agents, a multistage emulsion polymerization yielding a polymer dispersion with at least two phases and at least one defined soft phase with a T_{g} in the range of −15 to 30° C. and at least one hard phase with a T_{g} in the range from 50 to 100° C., or a gradually varying polymer composition with a broad T_{g} range may be preferable.

Referenced herein are midpoint glass transition temperatures as measured by differential scanning calorimetry (DSC) according to ISO 16805.

The present emulsion polymerization process is carried out in the presence of a stabilization system which comprises one or more stabilizers selected from protective colloids, anionic and/or non-ionic surfactants and mixtures thereof. Generally, the stabilizer(s) are present in the aqueous polymerization mixture in an amount between 0.5 and 15% by weight based on the total weight of monomer(s) in the mixture. Surfactant stabilizers are preferred.

Suitable nonionic surfactants which can be used as stabilizers in the present process include polyoxyethylene condensates, although it is generally preferred to minimize the use of ethoxylated nonionics based on alkylphenols (APEs). For purposes of this invention, dispersions and coating compositions are considered to be substantially free of APEs if they contain less than 500 ppm of alkylphenol ethoxylates. Exemplary polyoxyethylene condensates that can be used include polyoxyethylene aliphatic ethers, such as polyoxyethylene lauryl ether and polyoxyethylene oleyl ether; polyoxyethylene alkaryl ethers, such as polyoxyethylene nonylphenol ether and polyoxyethylene octylphenol ether; polyoxyethylene esters of higher fatty acids, such as polyoxyethylene laurate and polyoxyethylene oleate, as well as condensates of ethylene oxide with resin acids and tall oil acids; polyoxyethylene amide and amine condensates such as N-polyoxyethylene lauramide, and N-lauryl-N-polyoxyethylene amine and the like; and polyoxyethylene thio-ethers such as polyoxyethylene n-dodecyl thio-ether.

Nonionic surfactants that can be used also include a series of surface active agents available from BASF under the Pluronic™ and Tetronic™ trade names. Pluronic surfactants are ethylene oxide (EO)/propylene oxide (PO)/ethylene oxide block copolymers that are prepared by the controlled addition of PO to the two hydroxyl groups of propylene glycol. EO is then added to sandwich this hydrophobe between two hydrophilic groups, controlled by length to constitute from 10% to 80% (w/w) of the final molecule. PO/EO/PO block copolymers also available under the trade name Pluronic and are prepared by adding EO to ethylene glycol to provide a hydrophile of designated molecular weight. PO is then added to obtain hydrophobic blocks on the outside of the molecule. Tetronic surfactants are tetra-functional block copolymers derived from the sequential addition of PO and EO to ethylene-diamine. Tetronic surfactants are produced by the sequential addition of EO and PO to ethylene-diamine. In addition, a series of ethylene oxide adducts of acetyleneic glycols, sold commercially by Air Products under the Surfynol™ trade name, are suitable as nonionic surfactants. Additional examples of nonionic surfactants include Disponil™ A 3065 (alcohol ethoxylate), Emulsogen™ EPN 407 (alkyl polyglycol ether with 40 EO), and Emulsogen™ EPN 287 (alkyl polyglycol ether with 28 EO).

Suitable anionic surfactants comprise alkyl-, aryl- or alkylaryl-sulfonates and alkyl, aryl or alkylaryl sulfates, phosphates or phosphonates, whereby it also is possible for oligo- or polyethylene oxide units to be located between the hydrocarbon radical and the anionic group. The polymer dispersion may be stabilized by a combination of nonionic and anionic surfactants. Preferably, the dispersion is stabilized by anionic surfactants alone. Typical examples of anionic surfactants include sodium lauryl sulfate, sodium undecylglycol ether sulfate, sodium octylphenol glycol ether sulfate, sodium dodecylbenzene sulfonate, sodium lauryl ether sulfate, and ammonium tri-tert-butylphenol glycol ether sulfate. Preferred anionic surfactants are those not comprising APE-structural units.

Also suitable as stabilizers for the present dispersions are copolymerizable nonionic and anionic surfactants such as those disclosed in US 2014/0243552. Other suitable copolymerizable surfactants are sold under the trade names Hitenol BC, Hitenol KH, Hitenol AR, Adeka Reasoap SR, and Adeka Reasoap ER.

Conventionally, various protective colloids such as carboxymethyl cellulose (CMC), hydroxyethyl cellulose (HEC) and other conventional protective colloid-forming materials have also been used to stabilize polymer latex compositions of the types hereinbefore described, instead of or in addition to the surfactant emulsifiers. In one embodiment, the dispersions and compositions herein can contain up to about 5 wt % of protective colloid stabilizing agents, based on the total amount of copolymers in the dispersions or compositions being stabilized.

In another embodiment, the dispersions and compositions herein can be substantially free of such protective colloids as stabilizing agents. Such dispersions are considered to be “substantially free” of protective colloids if protective colloids comprise no more than 0.5 wt % of the dispersions, based on the total amount of copolymers in the dispersions being stabilized.

On completion of the polymerization, a further, preferably chemical after-treatment, especially with redox catalysts, for example combinations of the above-mentioned oxidizing agents and reducing agents, may follow to reduce the level of residual unreacted monomer on the product. In addition, residual monomer can be removed in known manner, for example by physical demonomerization, i.e. distillative removal, especially by means of steam distillation, or by stripping with an inert gas. A particularly efficient combination uses both physical and chemical methods, which permits lowering of the residual monomers to very low contents (<1000 ppm, preferably <100 ppm).

The polymerized particles produced by the present process typically have a weight-averaged diameter of less than 200 nm, preferably less than 150 nm, as measured by a combination of laser diffraction and polarization intensity differential scattering (PIDS) using a Beckman Coulter LS 13320 Particle Size Analyzer.

In addition to monomers described herein, the final polymer dispersion employed herein contains a water-soluble cross-linking agent comprising lysine or a salt thereof, such as lysine hydrochloride or lysine acetate. The amino groups of such a cross-linking agent will react with 1,3-dicarbonyl groups in the polymer as water is removed from the coating composition herein and as a film or coating is formed from the polymerized components. In some embodiments, the lysine or salt thereof may be present in the dispersion such that the molar ratio of amino functional groups provided by the lysine to carbonyl functional groups in the dispersion is from about 0.1 to about 2.0, preferably from about 0.5 to about 1.5, more preferably from about 0.75 to 1.33. The lysine may be added before or during the polymerization process but generally is added post polymerization.

After polymerization the dispersion is typically neutralized to alkaline pH. This can be accomplished by, for example, the addition of an organic or inorganic base, such as an amine, ammonia or an alkali metal hydroxide, such as potassium hydroxide. In some embodiments, it is preferred to effect neutralization with a nitrogen-free base.

In addition, before use, the copolymer dispersion can be dried to form a water redispersible powder, for example, to assist storage or transportation.

### Coating Composition

The aqueous polymer dispersions described herein are stable fluid systems which can be used to produce coating compositions suitable for use in paints, such as high gloss trim paints, lacquers and varnishes. In addition, coating compositions produced from the present aqueous polymer dispersions can be used in adhesives, such as pressure-sensitive adhesives, and printing inks.

When used in paint applications, the aqueous polymer dispersions are typically combined with one or more conventional fillers and/or pigments. In this context, pigments are understood as meaning solids which have a refractive index greater than or equal to 1.75, whereas fillers are understood as meaning solids which have a refractive index of less than 1.75.

Preferred fillers useful in the paint compositions herein can be, for example, calcium carbonate, magnesite, dolomite, kaolin, mica, talc, silica, calcium sulfate, feldspar, barium sulfate and opaque polymer. Examples of white pigments useful in the paint compositions herein can be zinc oxide, zinc sulfide, basic lead carbonate, antimony trioxide, lithopone (zinc sulfide+barium sulfate) and, preferably, titanium dioxide. Examples of inorganic colored pigments which may preferably be used in the paint compositions herein include iron oxides, carbon black, graphite, luminescent pigments, zinc yellow, zinc green, Paris blue, ultramarine, manganese black, antimony black, manganese violet or Schweinfurt green. Suitable organic colored pigments preferably are, for example, sepia, gamboge, Cassel brown, toluidine red, para red, Hansa yellow, indigo, azo dyes, anthraquinone and indigo dyes as well as dioxazine, quinacridone, phthalocyanin, isoindolinone and metal complex pigments of the azomethine series.

The fillers may be used as individual components. Mixtures of fillers such as, for example, calcium carbonate/kaolin and calcium carbonate/kaolin/talc have also been found to be particularly useful in practice. To increase the hiding power of the coating and to save on titanium dioxide, finely divided fillers such as, for example, finely divided calcium carbonate and mixtures of various calcium carbonates with different particle size distribution are frequently used. Calcined clays are commonly used to increase film dry opacity as they help incorporate air voids into the dry film. Air voids create a big difference in refractive index in the film and scatter light, yielding more opacity in the film once cured. To adjust the hiding power, the shade and the depth of color of the coatings formed, the fillers are mixed with appropriate amounts of white pigment and inorganic and/or organic colored pigments.

To disperse the fillers and pigments in water, auxiliaries based on anionic or non-ionic wetting agents, such as preferably, for example, sodium pyrophosphate, sodium polyphosphate, naphthalenesulfonate, sodium polyacrylate, sodium polymaleinates and polyphosphonates such as sodium 1-hydroxyethane-1,1-diphosphonate and sodium nitrilotris(methylenephosphonate) may be added.

Thickeners may also be added to the coating compositions described herein. Thickeners which may be used include, inter alia, sodium polyacrylate and water-soluble copolymers based on acrylic and methacrylic acid, such as acrylic acid/acrylamide and methacrylic acid/acrylic ester copolymers. Hydrophobically-modified alkali soluble (acrylic) emulsions (HASE), hydrophobically-modified ethoxylate (poly)urethanes (HEUR), and polyether polyols (PEPO) are also available. Inorganic thickeners, such as, for example, bentonites or hectorite, may also be used.

For various applications, it is sometimes also desirable to include small amounts of other additives, such as biocides, pH modifiers, and antifoamers, in the coating compositions described herein. This may be done in a conventional manner and at any convenient point in the preparation of the latexes.

Paint and lacquer coatings produced from the coating dispersions described herein are found to exhibit excellent mechanical properties as well as enhanced chemical and stain resistance.

When formulated into adhesives, the aqueous copolymer dispersions described herein may be combined with additives which are typical for use in the production of dispersion-based adhesives. Suitable additives include, for example, film-forming assistants, such as white spirit, Texanol®, TxiB®, butyl glycol, butyldiglycol, butyldipropylene glycol, and butyltripropylene glycol, toluene; plasticizers, such as dimethyl phthalate, dibutyl phthalate, diisobutyl phthalate, diisobutyl adipate, Coasol B®, Plastilit 3060®, and Triazetin®; wetting agents, such as AMP 90®, TegoWet 280®, Fluowet PE®; thickeners, such as polyacrylates or polyurethanes, such as Borchigel L759® and Tafigel PUR 60®; defoamers, such as mineral oil defoamers or silicone defoamers; UV protectants, such as Tinuvin 1130®, subsequently added stabilizing polymers, such as polyvinyl alcohol or cellulose ethers, and other additives and auxiliaries of the kind typical for the formulation of adhesives.

The fraction of these additives in the final dispersion-based adhesive can be up to 25% by weight, preferably 2% to 15% by weight, and in particular 5% to 10% by weight, based on the dispersion.

Examples of suitable substrates that can be bonded using the present adhesive include metals, plastics, paint surfaces, paper, textiles, nonwovens or natural substances, such as wood. The substrates to be bonded may possess absorbent surfaces or hydrophobic surfaces. Examples of absorbent surfaces are papers, including paperboard and cardboard, and other fiber webs. Examples of hydrophobic surfaces are polymeric films (e.g., polyester film, polyolefin film such as polypropylene or polyethylene, for example, polystyrene film, acetate film) or papers with a UV varnish coating. Any desired combination may occur in practice.

When used in a printing ink, the aqueous copolymer dispersions described herein may be combined with a coloring agent, such as a pigment or dye, a moistening agent (humectant) for preventing the ink from drying at an ink-jet head, a permeating agent (penetrant) for adjusting the drying speed of the ink on the recording medium, as well as other conventionally known additives, if necessary. Such additives include, for example, surfactants, pH-adjusting agents, viscosity-adjusting agents, surface tension-adjusting agents, and fungicides.

The invention will now be more particularly described with reference to the following non-limiting Examples.

### Example 1 (Comparative, AAEM)

Emulsion polymerization of monomer feed 1, as described in Table 1, was conducted as follows. A 3 liter reactor equipped with a reflux condenser and an anchor stirrer was filled with 605 g of deionized (DI) water and 19.64 g of Emulsogen EPA 073, a 28% aqueous solution of a sodium alkyl ether sulfate with 7 ethylene oxide units. The reactor content was heated to 80° C. and 2.7% of feed 1 was added. A solution of 0.55 g ammonium persulfate in 11 g of water was added and the reactor contents were held at 80° C. for 15 min (seed polymerization). Subsequently, the remaining amount of feed 1 was added to the reactor over 180 min with a constant dosage rate. The reactor temperature during the feed addition was maintained at 80° C. After completion of the feed addition, the reactor temperature was raised to 85° C. for 60 minutes and then cooled to room temperature. 22 g of aqueous ammonium hydroxide solution (12.5%) were added to the dispersion 30 min after the completion of the feed addition. A defoamer solution (0.29 g Tego Foamex 805 in 11 g DI water) was added at room temperature.

The properties of the resulting polymer dispersion are summarized in Table 2.

### Example 1A (Inventive, AAEM/Lysine)

2.58 g of a 50 wt % solution of DL-lysine in water (Euro Kemical srl) were added to 200 g of the polymer dispersion obtained in Example 1.

### Example 2 (Comparative, DAAM)

The process of Example 1 was repeated with monomer feed 2 instead of monomer feed 1.

The properties of the resulting polymer dispersion are summarized in Table 2.

### Example 2A (Comparative, DAAM/ADH)

9.63 g of a 10 wt % solution of adipic dihydrazide (DSM) in water were added to 200 g of the polymer dispersion obtained in Example 2.

TABLE 1
Composition of the feeds (in grams)

| | Feed 1 | Feed 2 |
|---|---|---|
| DI water | 478.5 | 478.5 |
| Emulsogen EPA 073 | 39.3 | 39.3 |
| Ammonium persulfate | 2.8 | 2.8 |
| Methacrylic acid (MAA) | 22.0 | 22.0 |
| Diacetone acrylamide (DAAM) | 0 | 22.9 |
| Methyl methacrylate (MMA) | 517.0 | 517.0 |
| Butyl acrylate (BA) | 583.0 | 583.0 |
| 2-Acetoacetoxyethyl methacrylate (AAEM) | 46.8 | 0 |

TABLE 2
Properties of the polymer dispersions

| | | Brookfield | | | |
|---|---|---|---|---|---|
| | Solid content | viscosity | | | |
| | (%)¹ | (mPa s)² | pH | d_{w} (nm)³ | T_{g} (° C.)⁴ |
| Example 1 | 49.3 | 680 | 7.5 | 110 | 16.3 |
| Example 2 | 49.6 | 880 | 8.7 | 120 | 14.9 |

¹gravimetric determination after 24 h drying at 110° C.
²measurement conditions: 20° C., 20 rpm, spindle 2
³weight-average particle diameter as determined by a Beckman Coulter LS 13320 Particle Size Analyzer
⁴Glass transition temperature as measured by differential scanning calorimetry (DSC) according to ISO 16805

### Preparation of Clear Lacquers

The polymer dispersions, as obtained by Examples 1, 1A, 2, and 2A, were adjusted with aqueous ammonium hydroxide solution (12.5%) and DI water to a solid content of 46.0% and a pH value of 9.0.

These adjusted dispersions were used to prepare clear, unpigmented lacquers by mixing the ingredients in Table 3 at room temperature under stirring. The resulting lacquers had a solid content of approx. 32.5%.

TABLE 3
Clear lacquer composition

| | Parts per weight |
|---|---|
| Polymer dispersion as per Examples 1-2 (46%) | 700 |
| DI water | 150 |
| Tego Wet KL 245 (wetting agent) | 1 |
| Tafigel PUR 41 (thickener) | 4 |
| DI water | 80 |
| Tego Foamex 805 (defoamer) | 5 |
| Ammonium hydroxide (25%) | 1 |
| DI Water | 59 |
| Sum | 1000 |

Cross-linking improves the resistance of polymer films against chemicals and stains. Films of the clear lacquers were cast with a 300 μm scraper and dried for 7 days at 23° C. and at 50% relative humidity. 5 drops of an isopropanol/water mixture (1:1) were rubbed with circular motions into the films and the alteration of the surface was rated (5: no effect; 0: very strong effect). To evaluate stain resistance, 5 drops of red wine (pinot noir) and coffee (1 g/20 ml water) were placed on the lacquer films. Every hour, one drop was removed and the stain intensity was evaluated and rated (5: no stain, 1: very strong discoloration).

The chemical and stain resistances of the clear lacquers are displayed in Table 4. Cross-linking of the AAEM-containing polymer chains by lysine significantly improves the chemical and stain resistance of the lacquer, in a comparable manner to the conventional cross-linking system DAAM and ADH.

TABLE 4
Chemical and stain resistance of the clear lacquer films

| | Resistance against | | |
|---|---|---|---|
| | Isopropanol, 7 d | Red wine, 28 d | Coffee, 28 d |
| Example 1 | 3 | 1 | 2 |
| (AAEM) | | | |
| Example 1A | 4 | 4 | 4 |
| (AAEM/lysine) | | | |
| Example 2 | 2 | 2 | 2 |
| (DAAM) | | | |
| Example 2A | 5 | 3 | 4 |
| (DAAM/ADH) | | | |

Cross-linking also manifests in the mechanical properties of a polymer film. An increasing cross-linking density causes a decreasing mesh size and flexibility of the polymer chains and, hence, an increase of Young's modulus.

Films of the clear lacquers were cast with a 300 μm scraper onto polypropylene foil and dried for 7 days at 23° C. and at 50% relative humidity. The dried films with thicknesses of approx. 60 μm were separated from the PP foil and punched into 170×15 mm specimen.

Stress-strain measurements were conducted with a tensile tester (Zwick). The distance between the test clamps was 50 mm and the films were elongated with a velocity of 200 mm/min Young's modulus was determined by linear regression as the slope of the initial linear regions of the stress-strain curves. Reported are the means of four measurements.

TABLE 5
Mechanical properties of the clear lacquer films

| | Young's modulus | Elongation at break | stress at break |
|---|---|---|---|
| | (N/mm²) | (%) | (N/mm²) |
| Example 1 | 64 | 442 | 8.7 |
| (AAEM) | | | |
| Example 1A | 142 | 283 | 9.2 |
| (AAEM/lysine) | | | |
| Example 2 | 57 | 452 | 9.0 |
| (DAAM) | | | |
| Example 2A | 116 | 266 | 10.6 |
| (DAAM/ADH) | | | |

As can be seen in Table 5, cross-linking of the AAEM-containing polymer chains by lysine significantly increases Young's modulus by a factor of 2.2. An effect of comparable magnitude (factor 2.0) is achieved with the conventional cross-linking system DAAM and ADH. Cross-linking also leads to a reduced elongation at break due to the formation of a more rigid polymer network. Both AAEM/lysine and DAAM/ADH cross-linking systems exhibit increased tensile stresses at break compared to the non-cross-linked polymer films, which indicates increased tensile strengths and mechanical stabilities of the lacquers.

In summary, the use of lysine as a cross-linking agent in combination with an acetoacetoxy-functional polymer significantly improves the chemical and mechanical resistances of coatings. Effects comparable to the conventional, but environmentally undesirable DAAM/ADH cross-linking system can be achieved.

While the present invention has been described and illustrated by reference to a particular embodiment, those of ordinary skill in the art will appreciate that the invention lends itself to variations not necessarily illustrated herein. For this reason, then, reference should be made solely to the appended claims for purposes of determining the true scope of the present invention.

1. An aqueous cross-linkable copolymer dispersion formed by emulsion polymerization of a monomer mixture comprising at least one ethylenically unsaturated main monomer and at least one 1,3-dicarbonyl functionalized monomer; and lysine or a salt thereof.

2. The dispersion of claim 1, wherein the at least one ethylenically unsaturated main monomer is selected from the group consisting of esters of ethylenically unsaturated carboxylic acids, vinyl esters of C₁-C₁₈ alkanoic acids, vinyl-aromatic compounds having up to 20 carbon atoms, vinyl esters of aromatic acids, C₂-C₈ aliphatic hydrocarbons with 1 or 2 double bonds, ethylenically unsaturated nitriles, vinyl halides, vinyl ethers of C₁-C₁₀ alcohols, and mixtures of these monomers.

3. The dispersion of claim 1, wherein said at least one ethylenically unsaturated main monomer comprises at least one C₁-C₁₂-alkyl ester of acrylic or methacrylic acid.

4. The dispersion of claim 1, wherein the monomer mixture comprises from 50 to 99 pphm of one or more C₁-C₁₂ alkyl esters of acrylic and methacrylic acid.

5. The dispersion of claim 1, wherein the monomer mixture comprises from 0.5 to 10 pphm of at least one 1,3-dicarbonyl functionalized monomer.

6. The dispersion of claim 1, wherein the at least one 1,3-dicarbonyl functionalized monomer comprises an acetoacetyl group.

7. The dispersion of claim 1, wherein the at least one 1,3-dicarbonyl functionalized monomer comprises an acetoacetoxyalkyl ester of acrylic or methacrylic acid.

8. The dispersion of claim 1, wherein the at least one 1,3-dicarbonyl functionalized monomer comprises 2-acetoacetoxyethyl methacrylate.

9. The dispersion of claim 1, wherein the copolymer dispersion is produced by emulsion polymerization in at least two stages, wherein the monomer mixture polymerized in at least one stage comprises at least one 1,3-dicarbonyl functionalized monomer.

10. The dispersion of claim 1, wherein the lysine comprises a dl-racemic mixture.

11. The dispersion of claim 1, wherein the weight average particle size of the polymer particles is below 200 nm.

12. The dispersion of claim 1, wherein the weight average particle size of the polymer particles is below 150 nm.

13. The dispersion of claim 1, wherein lysine or a salt thereof is present in an amount such that the molar ratio of amino groups to carbonyl groups in the dispersion is from about 0.1 to about 2.0.

14. The dispersion of claim 1, wherein lysine or a salt thereof is present in an amount such that the molar ratio of amino groups to carbonyl groups in the dispersion is from about 0.5 to about 1.5.

15. The dispersion of claim 1, wherein lysine or a salt thereof is present in an amount such that the molar ratio of amino groups to carbonyl groups in the dispersion is from about 0.75 to about 1.33.

16. A water redispersible powder comprising a dried form of the dispersion of claim 1.

17. A coating composition comprising the dispersion of claim 1.

18. A paint or lacquer comprising the coating composition of claim 17.

19. An adhesive comprising the coating composition of claim 17.

20. A printing ink comprising the coating composition of claim 17.
